(19) United States
(12) Patent Application Publication
(10) Pub. No.: US 2022/0322633 A1
(43) Pub. Date: Oct. 13, 2022

(54) Foldable Pet Bed

(71) Applicant: Theofore J. Glover, Westby, WI (US)

(72) Inventor: Theodore J. Glover, Westby, WI (US)

(21) Appl. No.: 17/709,363

(22) Filed: Mar. 30, 2022

Related U.S. Application Data
(60) Provisional application No. 63/169,199, filed on Mar. 31, 2021.

(51) Int. Cl. A01K 1/035

(52) U.S. Cl. CPC A01K 1/0353

(57) ABSTRACT

In at least one embodiment, a pet bed can be folded from a shipping configuration to a bed configuration. In some embodiments, the pet bed is generally flat in the shipping configuration. In some embodiments, the pet bed has at least some curved or otherwise nonlinear edges. In some embodiments, some walls of the bed have curved upper edges along with straight lower edges. Some embodiments include multiple tabs and mating slots that force some of the bed's walls into a curved shape. In some embodiments, the pet bed is comprised of a unitary piece of cardboard. In some embodiments, the pet bed includes hollow chambers of air near the bed's outer perimeter.

### CROSS-REFERENCE TO RELATED APPLICATIONS

This application claims the benefit of U.S. Patent Application No. 63/169,199, filed Mar. 31, 2021, the entire content of which is hereby incorporated herein by reference.

### BACKGROUND OF THE INVENTION

This invention relates to pet beds and similar containers. Pet beds are generally known in the art.

Pet beds are often made from fabrics and stuffed with soft materials, and can be relatively expensive. Pet beds can also be bulky, making them difficult to store and ship.

There remains a need for pet beds capable of being shipped and stored economically.

There remains a need for low cost pet beds that are desirable to animals.

All US patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well only for the purposes of complying with 37 C.F.R. 1.72. The abstract is not intended to be used for interpreting the scope of the claims.

### BRIEF SUMMARY OF THE INVENTION

In some embodiments, a pet bed comprises a floor, a first inner sidewall, a second inner sidewall, a first inner end wall and a second inner end wall. The first and second inner sidewalls are oriented at equal but opposite angles to the floor. The first and second inner end walls are oriented at equal but opposite angles to the floor. The pet bed comprises a single piece of material.

In some embodiments, a base layer of material is located under the floor. In some embodiments, a subfloor layer is located between the floor and the base layer.

In some embodiments, the inner sidewalls attach to the inner end walls. In some embodiments, the inner end walls comprise slots and the inner sidewalls comprise tabs oriented in the respective slots.

In some embodiments, a distal edge of the floor engages the second inner end wall. In some embodiments, the second inner end wall comprises a slot and the distal edge of the floor comprises a tab oriented in the slot.

In some embodiments, the pet bed has a first configuration comprising a flat sheet of material and a second configuration comprising a folded configuration.

In some embodiments, a base of the pet bed comprises a larger area than the floor. In some embodiments, a first outer sidewall is attached to the first inner sidewall and a chamber is defined between the base, the first outer sidewall and the first inner sidewall. In some embodiments, a first outer end wall is attached to the first inner end wall, a chamber defined between the base, the first outer end wall and the first inner end wall.

In some embodiments, a pet bed is foldable from a shipping configuration to a bed configuration, the pet bed comprising a first inner wall and a first outer wall. In the shipping configuration, the first inner wall and the first outer wall being substantially coplanar. In the bed configuration, a chamber is defined between the first inner wall and the first outer wall.

In some embodiments, the first inner wall is nonplanar.

In some embodiments, the first outer wall is attached to the first inner wall along a first upper edge. In some embodiments, the first upper edge is nonlinear.

In some embodiments, the first outer wall comprises a first outer lower edge that is linear.

In some embodiments, the first inner wall comprises a first inner lower edge that is nonlinear and spaced apart from the first outer wall.

In some embodiments, the pet bed comprises a first inner end wall attached to the first inner side wall.

In some embodiments, the inner sidewall comprises a first tab and the inner end wall comprises a first slot. In the shipping configuration, the first tab spaced apart from the first slot. In the bed configuration, the first tab oriented in the first slot.

In some embodiments, the inner sidewall comprises a second tab and the floor comprises a second slot. In the shipping configuration, the second tab spaced apart from the second slot. In the bed configuration, the second tab oriented in the second slot.

In some embodiments, pet bed comprises a unitary piece of cardboard.

In some embodiments, a pet bed comprises a first outer wall and a first inner wall. The first outer wall comprises a first outer lower edge and a first upper edge. The first outer lower edge is linear and the first upper edge is nonlinear. The first inner wall is attached to the first outer wall along the first upper edge. The first inner wall comprises a first inner lower edge spaced apart from the first outer lower edge.

In some embodiments, the first upper edge is curved. In some embodiments, the first upper edge is concave with respect to an interior of the pet bed.

In some embodiments, the pet bed comprises a lowermost peripheral edge that includes the first outer lower edge and an upper most peripheral edge that includes the first upper edge. The upper most peripheral edge comprises curvature and the lowermost peripheral edge is substantially rectangular.

In some embodiments, a perimeter of the upper most peripheral edge is greater than a perimeter of the lowermost peripheral edge.

In some embodiments, the first inner wall is bowed toward the first outer wall.

In some embodiments, the pet bed defines a chamber between the first outer wall and the first inner wall.

In some embodiments, the first outer wall and the first inner wall are comprised of a unitary piece of material. In some embodiments, the material comprises cardboard.

In some embodiments, a pet bed comprises a first configuration comprising a blank of sheet-type material. In the first configuration, the length and width of the blank are substantially greater than the thickness. In some embodiments, the pet bed comprises a second configuration wherein the blank of sheet-type material has been folded to form a pet bed comprising an interior cavity.

In some embodiments, the pet bed comprises a plurality of inner walls and a plurality of outer walls. The plurality of inner walls comprise a first inner end wall, a second inner end wall, a first inner sidewall and a second inner sidewall. The plurality of outer walls comprises a first outer end wall, a second outer end wall, a first outer sidewall and a second outer sidewall. In the first configuration, the second outer end wall and the second outer sidewall are flat and coplanar. In the second configuration, second outer end wall and the second outer sidewall are oriented at a non-zero angle to one another.

In some embodiments, the pet bed comprises a third orientation wherein the second outer end wall and the second outer sidewall are flat and parallel to one another but not coplanar.

In some embodiments, the pet bed comprises a floor. In the first configuration, the floor and the second outer end wall are flat and coplanar. In the third configuration, the floor and the second outer end wall are flat and parallel to one another but not coplanar.

In some embodiments, the pet bed comprises a bonded joint between at least two outer walls of the plurality of outer walls when the pet bed is in the bed configuration.

In some embodiments, a pet bed is foldable from a first orientation to a second orientation shaped differently from the first orientation. The pet bed comprises a floor, an inner sidewall and an inner end wall. The inner sidewall and the inner end wall are coplanar in the first orientation. The second orientation comprises an interior cavity defined by the floor, the inner sidewall and the inner end wall. The inner sidewall is oriented at a non-orthogonal angle to the floor and the inner end wall is oriented at a non-orthogonal angle to the floor.

In some embodiments, the pet bed comprises a base comprising a rectangular perimeter. The pet bed comprises an upper perimeter comprising four curved sides aligned above the rectangular perimeter. A length of the upper perimeter is greater than a length of the rectangular perimeter. In some embodiments, the upper perimeter comprises four corners aligned above corners of the rectangular perimeter.

In some embodiments, a pet bed comprises an inner wall attached to an outer wall. The inner wall and the outer wall are coplanar in the first orientation. In the second orientation, the inner wall is nonparallel to the outer wall and an airspace is defined between the inner wall and the outer wall.

These and other embodiments which characterize the invention are pointed out with particularity in the claims annexed hereto and forming a part hereof. However, for a better understanding of the invention, its advantages and objectives obtained by its use, reference can be made to the drawings which form a further part hereof and the accompanying descriptive matter, in which there are illustrated and described various embodiments of the invention.

### BRIEF DESCRIPTION OF THE DRAWINGS

A detailed description of the invention is hereafter described with specific reference being made to the drawings.

FIG. 1 is a perspective view showing an embodiment of a pet bed in a bed configuration.

FIG. 2 shows the pet bed of FIG. 1 in a generally flat precursor configuration.

FIGS. 3-9 show an embodiment of a pet bed being folded from a shipping configuration to a bed configuration.

FIG. 10 is a top view of the pet bed shown in FIG. 1.

FIG. 11 is a bottom view of the pet bed shown in FIG. 1.

FIG. 12 is a cross-sectional view taken along line 12-12 of FIG. 10.

FIG. 13 is a cross-sectional view taken along line 13-13 of FIG. 10.

FIG. 14 is another view of the pet bed of FIG. 1 in the generally flat precursor configuration.

FIG. 15 shows the pet bed of FIG. 1 but in one example of a shipping configuration.

FIG. 16 is similar to FIG. 15 but showing the pet bed in another example shipping configuration.

### DETAILED DESCRIPTION OF THE INVENTION

While this invention may be embodied in many different forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

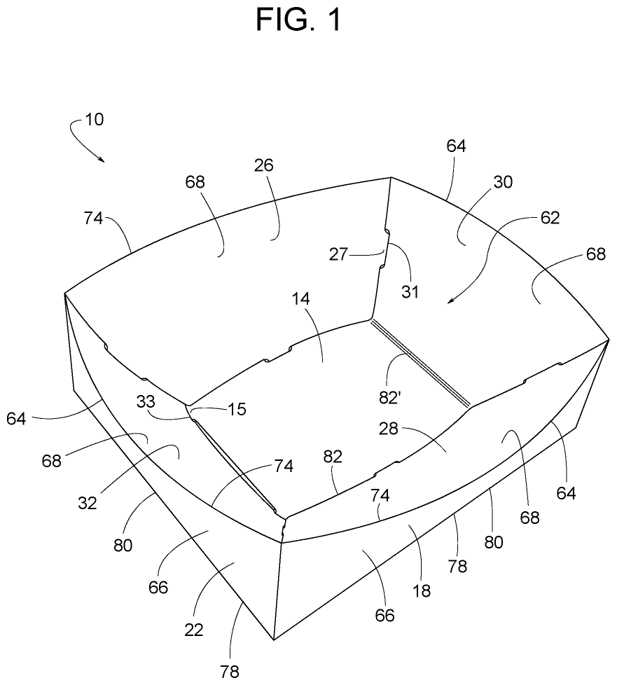

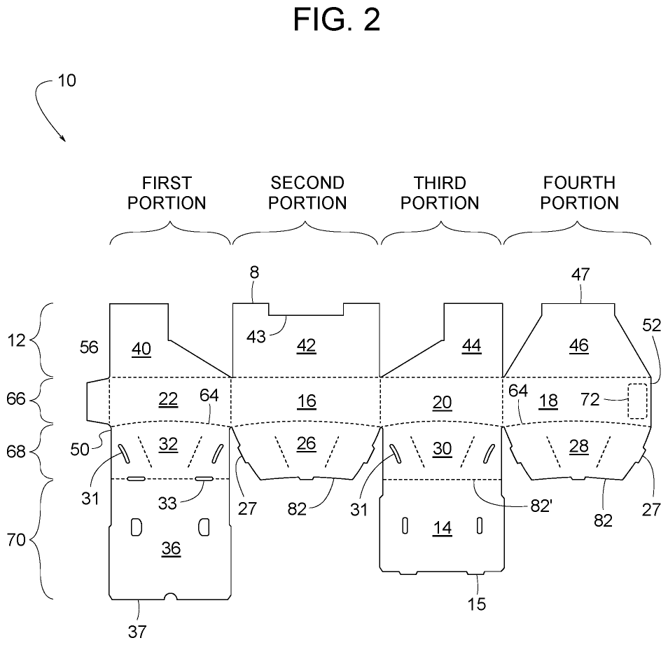

FIGS. 1, 9-13 show an embodiment of a pet bed 10 in a bed configuration. FIGS. 2 and 14 show the pet bed 10 in a precursor configuration. And FIGS. 15 and 16 shown the pet bed 10 in two different shipping configurations.

In some embodiments, the pet bed 10 comprises a floor structure 70, a plurality of outer walls 66, and a plurality of inner walls 68. In some embodiments, the floor structure 70 comprises a floor 14, a subfloor 36, and a base 12.

In some embodiments, the plurality of outer walls 66 comprise a first outer sidewall 16, an opposed second outer sidewall 18, a first outer end wall 20 and an opposed second outer end wall 22.

In some embodiments, the plurality of inner walls 68 comprise a first inner sidewall 26, an opposed second inner sidewall 28, a first inner end wall 30, and an opposed second inner end wall 32.

In some embodiments, an interior space 62 or cavity of the pet bed 10 is defined by the floor 14, first and second inner sidewalls 26, 28 and first and second inner end walls 30, 32.

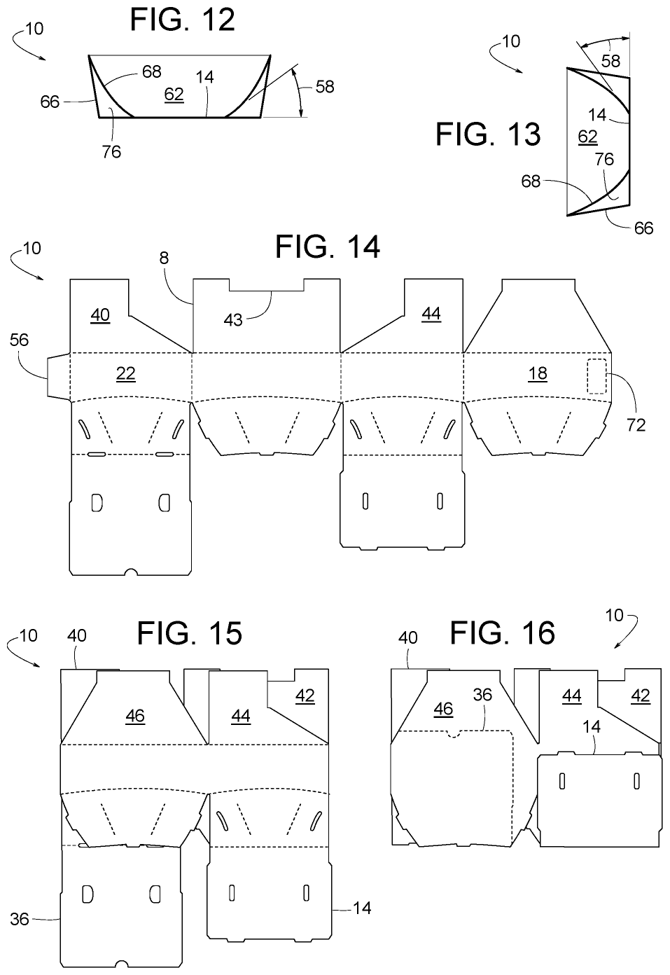

In some embodiments, each of the inner side walls 26, 28 and end walls 30, 32 are angled with respect to the floor 14, and angled with respect to their adjacent outer wall 16, 18, 20, 22. The inner walls 26, 28, 30, 32 can be oriented at any suitable angle to the floor 14. In some embodiments, the inner side walls 26, 28 are oriented at equal but opposite angles to each other. In some embodiments, the inner end walls 30, 32 are oriented at equal but opposite angles to each other. In some embodiments, the inner side walls 26, 28 are oriented at the same angle as the inner end walls 30, 32. In some embodiments, the inner side walls 26, 28 are oriented at a first angle and the inner end walls 30, 32 are oriented at a different, second angle. In some embodiments, the inner side walls 26, 28 and/or end walls 30, 32 are oriented at an angle 58 (see FIGS. 12 and 13) ranging from 20 degrees to 70 degrees with respect to the floor 14. In some embodiments, the inner side walls 26, 28 and/or end walls 30, 32 are oriented at an angle ranging from 30 degrees to 60 degrees with respect to the floor 14. In some embodiments, the inner side walls 26, 28 and/or end walls 30, 32 are oriented at an angle ranging from 40 degrees to 50 degrees with respect to the floor 14.

The angled inner side walls 26, 28 and end walls 30, 32 provide the pet bed 10 with structural rigidity and may provide a pet 60 (FIG. 9) occupying the pet bed 10 with comfort and security.

In some embodiments, one or more of the upper edges 64 of the outer sidewalls 16, 18 and end walls 20, 22 can be curved along their length, for example bowing outward and being concave with respect to the inner space 62. This provides an interior space 62 that is more comfortable for a pet 60 to occupy.

In some embodiments, pet bed 10 has an uppermost peripheral edge 74 and a lowermost peripheral edge 78. The uppermost peripheral edge 74 includes each of the upper edges 64. In some embodiments, most of the uppermost peripheral edge 74 is curved when the pet bed 10 is in the bed configuration.

The lowermost peripheral edge 78 includes each outer lower edge 80 at the bottom of each outer wall of the plurality of outer walls 66. In some embodiments, the lowermost peripheral edge 78 is substantially rectangular when the pet bed 10 is in the bed configuration. So in some embodiments, at least one outer lower edge 80 is substantially linear while at least one upper edge 64 is curved or at least nonlinear.

In some embodiments, the upper edges 64 are curved along their length and are concave with respect to the interior cavity 62. In some embodiments, the upper edges 64 comprise a perimeter that is greater than a perimeter of the lower edges 80.

In some embodiments, at least one inner wall of the plurality of inner walls 68 has an inner lower edge 82 that is nonlinear and spaced apart from the plurality of outer walls 66. In some embodiments, the inner lower edge 82 is curved. In some embodiments, the pet bed 10 in the bed configuration has at least one inner lower edge 82 that is nonlinear (e.g., on inner walls 26 and 28) and at least one inner lower edge 82′ that is substantially linear (e.g., on inner wall 30). In some embodiments, at least one inner wall of the plurality of inner walls 68 is bowed toward an adjacent outer wall of the plurality of outer walls 66. Such features of curvature, straightness, spacing and various combinations thereof provide the pet bed 10 with structural rigidity and possible comfort for the pet 60.

In some embodiments, the pet bed 10 is formed from a single piece of material. In some embodiments, the pet bed 10 is formed from a single type of material. In some embodiments, the pet bed 10 is formed from a corrugated material, such as corrugated cardboard or corrugated plastic. In some embodiments, the pet bed 10 is formed from a foam material. In some embodiments, the pet bed 10 comprises recycled material.

In some embodiments, the pet bed 10 is formed from a precursor of flat material that is folded to become a pet bed 10. FIG. 2 shows an embodiment of a flat sheet 8 that can be folded to form a pet bed 10 as shown in FIG. 1.

In some embodiments, a single piece of material comprises a plurality of adjacent areas, wherein each area will become a surface of a pet bed 10. In some embodiments, a flat sheet 8 of material comprises a plurality of adjacent areas, wherein each area will become a surface of a folded pet bed 10. Reference characters that are shown on FIG. 1 are shown on FIG. 2 and indicate similar surfaces or features.

In some embodiments, a pet bed 10 has a precursor configuration (FIGS. 2 and 14) that comprises a flat sheet 8 of material. The flat sheet 8 can define a plurality of contoured edges. In some embodiments, the flat sheet 8 comprises fold lines, for example as shown in dashed lines in FIG. 2. In some embodiments, a fold line will encourage the flat sheet 8 to fold on the fold line. In some examples, a fold line will simply be a visual indicator showing where the flat sheet 8 should be folded. Any suitable method can be used to create a fold line. In some embodiments, a fold line can comprise a physical score line, a visual marking (e.g., a printed line), a plurality of perforations, an indentation in the surface of the material, etc. In some embodiments, fold lines divide the flat sheet 8 into areas that become surfaces of the folded pet bed 10.

In some embodiments, the flat sheet 8 includes the base 12. In some embodiments, the base 12 comprises first base portion 40, a second base portion 42, a third base portion 44 and a fourth base portion 46. In some embodiments, each base portion 40, 42, 44, 46 is attached to a respective outer wall 22, 16, 20, 18. When the flat sheet 8 is folded, the base portions 40, 42, 44, 46 are folded together to form the base 12 of the pet bed 10.

In some embodiments, adjacent inner walls 26, 28, 30, 32 are configured to engage one another at one or more places along their length. In some embodiments, each of the inner end walls 30, 32 comprises one or more slots 31. In some embodiments, each of the inner sidewalls 26, 28 comprises one or more tabs 27, which can be received in a slot 31. The term, “slot” refers to any aperture, hole, notch, slit, or opening.

In some embodiments, the floor 14 is located adjacent the first inner end wall 30. In some embodiments, the floor 14 comprises one or more tabs 15, which can be received in one or more corresponding slots 33 in the second inner end wall 32.

In some embodiments, the flat sheet 8 comprises the subfloor 36 located adjacent the second inner end wall 32.

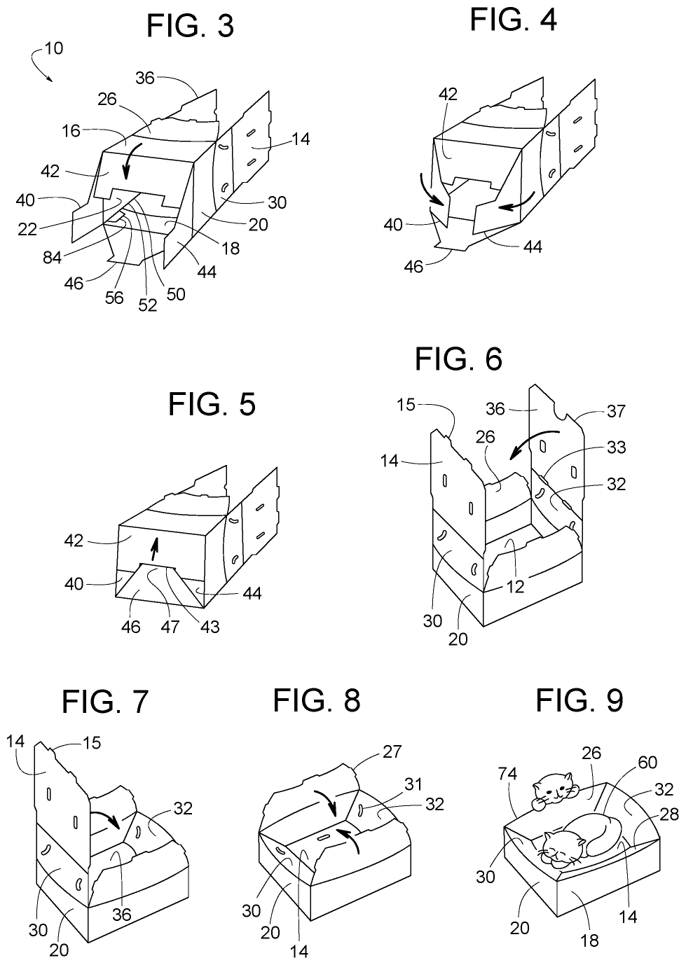

In some embodiments, the flat sheet 8 defines a first edge 50 and a second edge 52 that will be aligned with one another. In some embodiments, the flat sheet 8 comprises a tab 56 which, for example, can extend from the second end wall 22. The tab 56 can be adhesively bonded, taped, glued or otherwise attached to a certain area 72 or another portion of the pet bed 10 to prepare the pet bed 10 for a shipping configuration or a bed configuration. In examples where tab 56 is adhesively attached, the connection is considered a bonded joint 84 (FIG. 3). In some embodiments, a known hook-and-loop fastener can be used for connecting the tab 56 to the certain area 72. In addition or alternatively, a tab and mating slot arrangement can be used for connecting the second outer sidewall 18 to the second outer end wall 22.

FIG. 3 shows an embodiment of a pet bed 10 in a first intermediate assembly configuration. The first edge 50 and second edge 52 of the flat sheet 8 have been positioned directly adjacent to one another. The flat sheet 8 has been folded along lines separating the outer walls 16, 18, 20, 22 from one another and has assumed a generally rectangular cross-section. In some embodiments, the tab 56 can be bonded to the second outer sidewall 18.

The first, second third and fourth base portions 40, 42, 44, 46 can be folded as shown in FIGS. 4 and 5. The base portions can be secured in place using any suitable method. In some embodiments, one of the base portions can attach to another base portion. For example, as shown in FIG. 5, a base portion 42 can comprise a slot or recess 43 and another base portion 46 can comprise a tab or protrusion 47 that is received in the recess 43. The base portions 40, 42, 44, 46 form the base 12 of the pet bed 10.

FIG. 6 shows the pet bed 10 positioned on its base 12. The subfloor 36 can be brought downward by folding the pet bed 10 between the second inner and outer end walls 22, 32, and the subfloor 36 can be laid upon the base 12. A distal end 37 of the subfloor 36 can abut in inner side of the first outer end wall 20. The dimensions of the second inner end wall 32 and the subfloor 36 will cause the second inner end wall 32 to be inclined, as shown in FIG. 7.

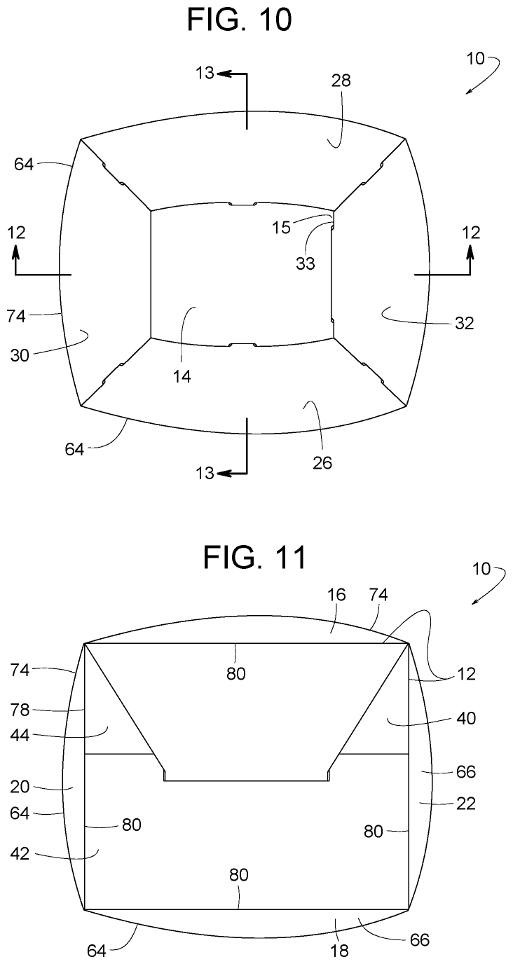

Next, the floor 14 can be brought downward by folding the pet bed 10 between the first inner and outer end walls 20, 30, and the floor 14 can be laid upon the subfloor 36. So in some embodiments, the subfloor 36 becomes sandwiched between the base 12 and the floor 14. In some embodiments, tabs 15 of the floor 14 can be received in slots 33 in the second inner end wall 32, as shown in FIGS. 1 and 10.

FIG. 9 shows the first and second inner sidewalls 26, 28 having been folded down. The inner sidewalls 26, 28 can be secured in place, for example by installing tabs 27 of the inner sidewalls 26, 28 into slots 31 in the inner end walls 30, 32. In some embodiments, the inner sidewalls 26, 28 include additional score lines to encourage the bowing shape shown in FIG. 1.

FIGS. 10 and 11 show respectively top and bottom views of the pet bed 10 in the bed configuration. In some examples, the base 12 is larger in area than the floor 14. This helps make the pet bed 10 more stable and less likely to tip over.

Referring to FIGS. 12 and 13, some embodiments of pet bed 10 have a chamber 76 between one or more inner walls (e.g., inner walls 26, 28, 30 and 32) and one or more outer walls (e.g., outer walls 16, 18, 20 and 22). In some examples, the chamber 76 is mostly hollow and filled with air. In some examples, chamber 76 might contain at least some article or material. The chamber 76 might help insulate the pet bed's interior space 62.

In some embodiments, the outer walls 66 are oriented at a non-orthogonal angle with respect to the base 12. In some embodiments, the outer sidewalls 16, 18 are oriented at equal but opposite angles. In some embodiments, the outer sidewalls 16, 18 diverge from the lower edges 80 to the upper edges 64. In some embodiments, the outer end walls 20, 22 are oriented at equal but opposite angles. In some embodiments, the outer end walls 20, 22 diverge from the lower edges 80 to the upper edges 64.

In some embodiments, each inner wall 68 portion is oriented at an angle to its respective outer wall 66 portion.

FIG. 14 shows that in some embodiments, the plurality of outer walls 66 and the plurality of inner walls 68 are substantially coplanar when the pet bed 10 is in the precursor configuration.

FIGS. 15 and 16 show portions of the flat sheet 8 folded over onto itself to provide more compact shipping configurations suitable for shipping or storage. In some shipping configurations, tab 56 is attached to a certain area 72 on sheet 8 such that the second outer end wall 22 adjoins the second outer sidewall 18. In some examples, the plurality of outer walls 66, the plurality of inner walls 68, the base 12, the floor 14 and the subfloor 36 lie substantially parallel to each other when the pet bed 10 is in the shipping configuration.

Referring to back FIG. 1 and other drawing figures, there are some additional features worth noting. In some embodiments, each outer wall of the plurality of outer walls 66 adjoins a corresponding inner wall of the plurality of inner walls 68 along an upper edge 74 that is curved or otherwise nonlinear. In some embodiments, upper edge 74 is a series of linear line segments that approximate a curved line.

In some embodiments, an inner lower edge 82 of an inner sidewall 26, 28 comprises a tab arranged to engage the floor 14. In some embodiments, the floor 14 comprises apertures and each tab is oriented is oriented in a respective aperture. In some embodiments, the subfloor 36 comprises apertures and the tabs extend into the subfloor 36.

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A pet bed foldable from a first orientation to a second orientation shaped differently from the first orientation, the pet bed comprising:
a floor, an inner sidewall and an inner end wall;
the inner sidewall and the inner end wall coplanar in the first orientation;
the second orientation comprising an interior cavity defined by the floor, the inner sidewall and the inner end wall, the inner sidewall oriented at a non-orthogonal angle to the floor, the inner end wall oriented at a non-orthogonal angle to the floor.

2. The pet bed of claim 1, the inner sidewall comprising an upper edge that is concave with respect to the interior cavity in the second orientation.

3. The pet bed of claim 2, wherein the upper edge comprises a score line in the first orientation, the score line comprising curvature along its length.

4. The pet bed of claim 3, comprising an outer sidewall attached to the inner sidewall at the upper edge.

5. The pet bed of claim 4, comprising an airspace between the inner sidewall and the outer sidewall in the second orientation.

7. The pet bed of claim 1, the inner sidewall contacting the inner end wall in the second orientation.

8. The pet bed of claim 1, the inner sidewall comprising a tab, the inner end wall comprising a slot, the tab oriented in the slot in the second orientation.

9. The pet bed of claim 1, the inner sidewall comprising a tab, the floor comprising a slot, the tab oriented in the slot in the second orientation.

10. The pet bed of claim 1, the floor attached to the first interior sidewall in the first orientation.

11. The pet bed of claim 1, comprising a base comprising an area greater than the floor.

12. The pet bed of claim 1, the inner sidewall comprising a first inner sidewall, the pet bed comprising a second inner sidewall, the first inner sidewall and the second inner sidewall oriented at equal but opposite angles to the floor.

13. The pet bed of claim 1, formed from a single piece of material.

14. A pet bed foldable from a first orientation to a second orientation shaped differently from the first orientation, the pet bed comprising:
a first outer wall comprising a first outer lower edge and a first upper edge, the first outer lower edge being linear, the first upper edge being nonlinear; and
a first inner wall attached to the first outer wall along the first upper edge, the first inner wall comprising a first inner lower edge spaced apart from the first outer lower edge.

15. The pet bed of claim 14, the first outer wall and the first inner wall coplanar in the first orientation.

16. The pet bed of claim 14, comprising a base comprising a rectangular perimeter comprising the first outer lower edge, an upper perimeter comprising the first upper edge, a length of the upper perimeter greater than a length of the rectangular perimeter.

17. A pet bed foldable from a first orientation to a second orientation shaped differently from the first orientation, the pet bed comprising:
an inner wall attached to an outer wall;
the inner wall and the outer wall coplanar in the first orientation;
the second orientation comprising an airspace between the inner wall and the outer wall, the inner wall nonparallel to the outer wall.

18. The pet bed of claim 17, comprising an upper edge between the inner wall and the outer wall, the upper edge comprising curvature.

19. The pet bed of claim 18, the upper edge comprising a score line in the first orientation.
